(19) United States
(12) Patent Application Publication
(10) Pub. No.: US 2009/0115585 A1
(43) Pub. Date: May 7, 2009

(54) SECURITY ACCESS SYSTEM, APPARATUS, AND METHOD

(76) Inventor: MINAS MINASSIAN, Vista, CA (US)

Correspondence Address: DIRECTED ELECTRONICS, INC., 1 VIPER WAY, VISTA, CA, 92061, US

(21) Appl. No.: 11/936,002

(22) Filed: Nov. 6, 2007

(51) Int. Cl. B60R 25/10

(52) U.S. Cl. 340/426.36

(57) ABSTRACT

A security access system and method is disclosed. In one embodiment, a vehicle access security system, comprising a transmitter element, a detector element, a receiver element, and a computational element is taught, wherein the transmitter element transmits a modulated vehicle access signal into a predetermined communications channel, which is detected by the detector element. The detector element is adapted to detect the modulated vehicle access signal and further adapted to have a detector output signal. The receiver element receives the detector output signal and performs at least one signal processing function, wherein the receiver element has a receiver output signal. The computational element accepts the receiver output signal and compares it to a predetermined access code to determine whether a user shall be granted access to the vehicle.

### BACKGROUND

1. Field

The present disclosure generally relates to apparatuses, system and methods for accessing a security system.

2. Related Art

Demand for convenience and security are two fundamental issues which drive secured access systems. As consumer electronics matures, a level of complexity and sophistication regarding such secured access systems improves. Modernly, radio frequency electronics devices are commonly used to grant a user access to a vehicle, home, or office such as for example a key FOB. Such radio frequency electronics devices have become a primary access tool, largely replacing older metallic keys previously used to access a vehicle or a home.

One issue that has only received minimal attention is backup solutions if a user is locked out of his/her vehicle, home or office. Such locking out of can occur when a user locks his/her keys in a vehicle or walks out of the house and locks the door, without a key to reenter the premises. One solution to address the issue of backup accessibility has been to hide a key locally, such as for example on the vehicle body, or under a planter on a user's home porch. Such solutions may further compromise security, as a burglar may access such back up solutions to gain unauthorized entry. Another solution to the backup issue has been to provide a key pad on the vehicle door or house door. Forgotten key passwords can thwart such backup access.

Therefore a need exists for a solution to the aforementioned problem of providing a backup security access system, which is inexpensive, reliable, easy to install, and easy to use. The present teachings provide such a backup system.

### SUMMARY

In one illustrative exemplary embodiment a vehicle access security system is disclosed, comprising a transmitter element, adapted to transmit a modulated vehicle access signal into a predetermined communications channel, the predetermined communications channel selected from a group consisting of, (i.) an acoustic communications channel, or (ii.) an optical communications channel. The vehicle access security system further comprising a detector element, adapted to detect the modulated vehicle access signal in the predetermined communications channel transmitted by the transmitter element, the detector element having a detector output signal. The vehicle access security system further comprising a receiver element, adapted to receive the detector output signal of the detector element, the receiver element further adapted to perform at least one signal processing function, the receiver element having a receiver output signal, wherein the at least one signal processing function is selected from the group consisting of, (i.) amplifying an amplitude of the detector output signal, (ii.) downconverting the detector output signal, (iii.) demodulating the detector output signal, or (iv.) correcting phase distortions in the detector output signal. And the vehicle access security system further comprising a computational element, adapted to accept the receiver output signal, the computational element further adapted to compare the receiver output signal with a predetermined access code, wherein the predetermined access code is stored in a memory element accessible by the computational element, whereby the computational element further calculates an output value of the computational element reflective of a comparative result of the receiver output signal with the predetermined access code.

In one illustrative exemplary embodiment a vehicle access security module is disclosed, comprising a detector element, adapted to detect a modulated vehicle access signal in a predetermined communications channel, the detector element having a detector output signal, the predetermined communications channel selected from a group consisting of, (i.) an acoustic communications channel or (ii.) an optical communications channel. The vehicle access security module further comprising a receiver element, adapted to receive the detector output signal of the detector element, the receiver element further adapted to perform at least one signal processing function, the receiver element having a receiver output signal, wherein the at least one signal processing function is selected from the group consisting of, (i.) amplifying an amplitude of the detector output signal, (ii.) downconverting the detector output signal, (iii.) demodulating the detector output signal, or (iv.) correcting phase distortions in the detector output signal. And the vehicle access security module further comprising a computational element, adapted to accept the receiver output signal, the computational element further adapted to compare the receiver output signal with a predetermined access code, wherein the predetermined access code is stored in a memory element accessible by the computational element, whereby the computational element further calculates an output value of the computational element reflective of a comparative result of the receiver output signal with the predetermined access code.

In one illustrative exemplary embodiment a security access system is disclosed, comprising a transmitter element, adapted to transmit a modulated access signal into a predetermined communications channel, the predetermined communications channel selected from a group consisting of, (i.) an acoustic communications channel, or (ii.) an optical communications channel. The security access system further comprising a detector element, adapted to detect the modulated access signal in the predetermined communications channel transmitted by the transmitter element, the detector element having a detector output signal. The security access system further comprising a receiver element, adapted to receive the detector output signal of the detector element, the receiver element further adapted to perform at least one signal processing function, the receiver element having a receiver output signal, wherein the at least one signal processing function is selected from the group consisting of, (i.) amplifying an amplitude of the detector output signal, (ii.) downconverting the detector output signal, (iii.) demodulating the detector output signal, or (iv.) correcting phase distortions in the detector output signal. And the security access module further comprising a computational element, adapted to accept the receiver output signal, the computational element further adapted to compare the receiver output signal with a predetermined access code, wherein the predetermined access code is stored in a memory element accessible by the computational element, whereby the computational element further calculates an output value of the computational element reflective of a comparative result of the receiver output signal with the predetermined access code.

### BRIEF DESCRIPTION OF THE DRAWINGS

Embodiments of the present disclosure will be more readily understood by reference to the following figures, in which like reference numbers and designations indicate like elements.

FIG. 1 illustrates one embodiment of a vehicle access security system according to the present teachings.

FIG. 2 illustrates one embodiment of a vehicle access security module according to the present teachings.

FIG. 3 illustrates one embodiment of a security access system according to the present teachings.

### DETAILED DESCRIPTION

### Overview

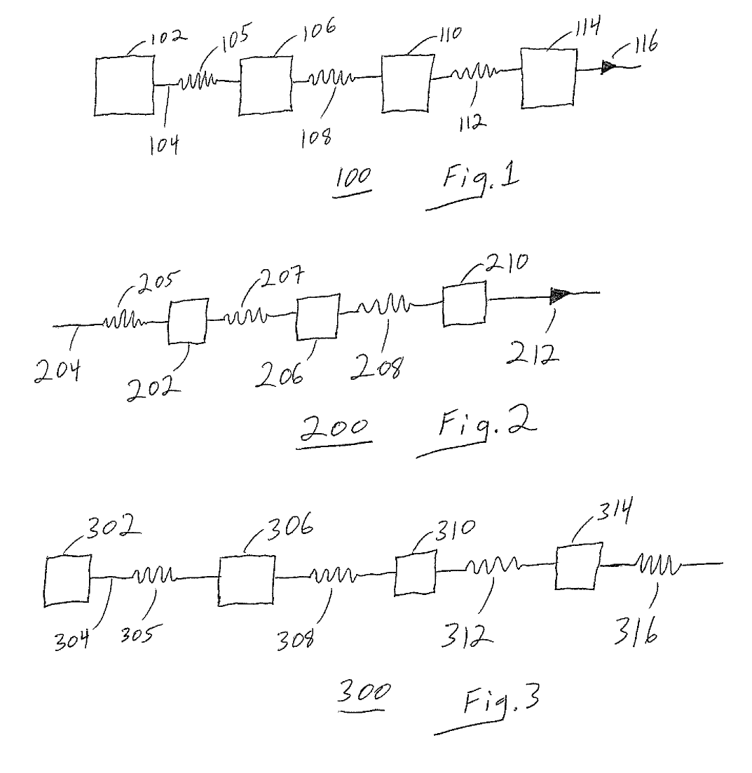

Embodiments for a vehicle access security system 100, a vehicle access security module 200, and a security access system 300 will now be described in detail, with reference made to FIGS. 1-3.

Referring now to FIG. 1, one exemplary illustrative embodiment of a vehicle access system 100 is disclosed. In the embodiment of FIG. 1, the vehicle access system 100 comprises a transmitter element 102, a detector element 106, a receiver element 110, and a computational element 114.

The transmitter element 102 is adapted to transmit into a predetermined communications channel 104 a modulated vehicle access signal 105. The modulated vehicle access signal 105 may comprise a modulation format, such as for example frequency modulation, amplitude modulation, phase modulation, quadrature phase shift keying, quadrature amplitude modulation, frequency shift keying, on-off keying, or literally any other form of modulation scheme.

In some embodiments of the present teachings, the predetermined communications channel 104 consists of an acoustic communications channel, such as for example, inter alia, an audio channel or an ultrasonic channel, wherein the modulated vehicle access signal 105 comprises an audio signal adapted for transmission into the audio communications channel. In some embodiments, an acoustic signal generation means, such as for example an analog or digital audio player device or a wireless telephone is used to generate the modulated vehicle access signal 105, such as an MP3 player or a key FOB. Literally any source capable of generating an audio signal may be used to generate the modulated vehicle access signal 105 for transmission into the acoustic communications channel.

In another embodiment, the predetermined communications channel 104 comprises an optical communications channel, such as for example, inter alia, an infrared communications channel, a visible light communications channel, a visible light communications channel, or an ultraviolet communications channel wherein the modulated vehicle access signal 105 comprises an optical signal adapted for transmission into the optical communications channel. In some embodiments, an optical signal generation means, such as for example a cellular telephone or camera is used to generate the modulated vehicle access signal 105. In one embodiment, a liquid crystal display (“LCD”), such as for example an LCD screen of a cellular telephone or camera is used to transmit the modulated vehicle access signal 105 in the optical communications channel.

The detector element 106 is adapted to detect the modulated vehicle access signal 105 in the predetermined communications channel 104 transmitted by the transmitter element 102. The detector element 106 further comprises a detector output signal 108. In one embodiment, the detector element 106 comprises an acoustic transducer, such as for example a microphone or an audio transducer, adapted to detect an acoustic signal in the communications channel 104. In one embodiment, the acoustic transducer transforms the acoustic signal into an electrical waveform. In other embodiments, the acoustic transducer detects the acoustic signal and outputs an acoustic waveform correlated to the acoustic signal. In other variations, the detector element 106 comprises an optical transducer element. In this embodiment, the modulated vehicle access signal 105 comprises an optical signal, adapted for transmission in an optical communications channel. The optical transducer element is adapted to detect the optical signal in the optical communications channel. In one embodiment, the optical transducer element is adapted to transform the optical signal into an electrical waveform. In other embodiments, the optical transducer element is adapted to transform the optical signal into, inter alia, an acoustic waveform or an optical waveform.

The receiver element 110 is adapted to receive the detector output signal 108 of the detector element 106. The receiver element 110 is further adapted to perform at least one signal processing function. The receiver element also comprises a receiver output signal 112. In one embodiment, the signal processing function comprises, inter alia, amplifying an amplitude of the detector output signal 108, downconverting the detector output signal 108, demodulating the detector output signal 108, and/or correcting phase distortions in the detector element output signal 108.

The vehicle access system 100 further comprises a computational element 114, adapted to accept the receiver output signal 112. The computational element 114 is further adapted to compare the receiver output signal 112 with a predetermined access code, wherein the predetermined access code is stored in a memory element accessible by the computational element 114. In one embodiment, the computational element 114 comprises a microprocessor element. The computational element 114 calculates an output value 116, reflective of a comparative result of the receiver output signal 112 with the predetermined access code. In one embodiment, the memory element comprises, inter alia, a magnetic storage medium, an optical storage medium, a semiconductor memory element, a compact disk element, a digital video disk element, an internet based database element such as the Internet, or a computer readable medium.

If the output value 116 approximately matches the predetermined access code, a user of a vehicle access security system is granted access to the vehicle. If, on the other hand, the output value 116 does not approximately match the predetermined access code, a user of a vehicle is denied access to the vehicle. In one embodiment, granting access to the vehicle comprises unlocking one or more doors of the vehicle. The scope of the term “vehicle” is intended to comprise, inter alia, automobiles, cars, trucks, vans, boats, trains, motorcycles, recreational vehicle, mobile home, trailer, and literally any other mode of transportation for which such a vehicle security module may be useful.

Referring now to FIG. 2, one exemplary embodiment of a vehicle access security module 200 is disclosed. In the embodiment of FIG. 2, the vehicle access security module 200 comprises a detector element 202, a receiver element 206, and a computational element 210.

The detector element 202 of the vehicle security access module 200 is adapted to detect, in a predetermined communications channel 204, a modulated vehicle access signal 205. The detector element 202 further comprises a detector output signal 207. In the various exemplary embodiments of the present teachings, the modulated vehicle access signal 205 may comprise, inter alia, a modulation format, such as for example frequency modulation, amplitude modulation, phase modulation, quadrature phase shift keying, quadrature amplitude modulation, frequency shift keying, on-off keying, or literally any other form of modulation scheme. In one embodiment of the present teachings, the predetermined communications channel 204 comprises an acoustic communications channel. In one variation of the exemplary embodiments, the acoustic communications channel comprises, inter alia, an audio communications channel or an ultrasonic communications channel. In one embodiment, the detector element 202 comprises an acoustic transducer, such as for example a microphone or an audio transducer, adapted to detect an acoustic signal in the communications channel 204. In one embodiment, the acoustic transducer transforms the acoustic signal into an electrical waveform. In other embodiments, the acoustic transducer detects the acoustic signal and outputs an acoustic waveform correlated to the acoustic signal.

In another embodiment, the predetermined communications channel 204 comprises an optical communications channel. In some embodiments of the present disclosure, the predetermined communications channel 204 comprises an infrared communications channel, a visible light communications channel, or an ultraviolet communications channel wherein the modulated vehicle access signal 205 comprises an optical signal adapted for transmission into the optical communications channel. In some embodiments, an optical signal generation means, such as for example a cellular telephone or camera is used to generate the modulated vehicle access signal 205. In certain variations of the exemplary embodiments, the detector element 202 comprises an optical transducer element. In this embodiment, the modulated vehicle access signal 205 comprises an optical signal, adapted for transmission in an optical communications channel. The optical transducer element is adapted to detect the optical signal in the optical communications channel. In one embodiment, the optical transducer element is adapted to transform the optical signal into an electrical waveform. In other embodiments, the optical transducer element is adapted to transform the optical signal into, inter alia, an acoustic waveform or an optical waveform. In one embodiment, a liquid crystal display (“LCD”), such as for example an LCD screen of a cellular telephone or camera is used to transmit the modulated vehicle access signal 205 in the optical communications channel.

The receiver element 206 of the vehicle security access module 200 is adapted to receive from the detector element 202 the detector output signal 207. The receiver element 206 is further adapted to perform at least one signal processing function. In the various exemplary embodiments of the present teachings, the signal processing function may include, inter alia, amplifying an amplitude of the detector output signal 207, downconverting the detector output signal 207, demodulating the detector output signal 207, and/or correcting phase distortions in the detector output signal 207. The receiver element 206 also comprises a receiver output signal 208.

The computational element 210 of the vehicle security access module 200 is adapted to accept the receiver output signal 208. The computational element 210 is further adapted to compare the receiver output signal 208 with a predetermined access code, wherein the predetermined access code is stored in a memory element accessible by the computational element 210. In one embodiment, the computational element 210 comprises a microprocessor element. The computational element 210 calculates an output value 212, reflective of a comparative result of the receiver output signal 208 with the predetermined access code. In one embodiment, the memory element comprises, inter alia, a magnetic storage medium, an optical storage medium, a semiconductor memory element, a compact disk element, a digital video disk element, an internet based database element such as the Internet, or a computer readable medium.

If the output value 212 approximately matches the predetermined access code, a user of a vehicle access security module is granted access to a vehicle. If, on the other hand, the output value 212 does not approximately match the predetermined access code, a user of a vehicle is denied access to the vehicle. In one embodiment, granting access to the vehicle comprises unlocking one or more doors of the vehicle. The scope of the term “vehicle” is intended to comprise, inter alia, automobiles, cars, trucks, vans, boats, trains, motorcycles, recreational vehicle, mobile home, trailer, and literally any other mode of transportation for which such a vehicle security module may be useful.

Referring now to FIG. 3, one exemplary illustrative embodiment of a security access system 300 is disclosed. In the embodiment of FIG. 3, the security access system 300 comprises a transmitter element 302, a detector element 306, a receiver element 310, and a computational element 314.

The transmitter element 302 is adapted to transmit into a predetermined communications channel 304 a modulated access signal 305. The modulated access signal 305 may comprise a modulation format, such as for example frequency modulation, amplitude modulation, phase modulation, quadrature phase shift keying, quadrature amplitude modulation, frequency shift keying, on-off keying, or literally any other form of modulation scheme.

In some embodiments of the present teachings, the predetermined communications channel 304 consists of an acoustic communications channel, such as for example, inter alia, an audio channel or an ultrasonic channel, wherein the modulated access signal 305 comprises an audio signal adapted for transmission into the audio communications channel. In some embodiments, an acoustic signal generation means, such as for example an analog or digital audio player device or a wireless telephone is used to generate the modulated access signal 305, such as an MP3 player or a key FOB. Literally any source capable of generating an audio signal may be used to generate the modulated access signal 305 for transmission into the acoustic communications channel.

In another embodiment, the predetermined communications channel 304 comprises an optical communications channel, such as for example, inter alia, an infrared communications channel, a visible light communications channel, or an ultraviolet communications channel wherein the modulated access signal 305 comprises an optical signal adapted for transmission into the optical communications channel. In some embodiments, an optical signal generation means, such as for example a cellular telephone or camera is used to generate the modulated access signal 305. In one embodiment, a liquid crystal display (“LCD”), such as for example an LCD screen of a cellular telephone or camera is used to transmit the modulated access signal 305 in the optical communications channel.

The detector element 306 is adapted to detect the modulated access signal 305 in the predetermined communications channel 304 transmitted by the transmitter element 302. The detector element 306 further comprises a detector output signal 308. In one embodiment, the detector element 306 comprises an acoustic transducer, such as for example a microphone or an audio transducer, adapted to detect an acoustic signal in the communications channel 304. In one embodiment, the acoustic transducer transforms the acoustic signal into an electrical waveform. In other embodiments, the acoustic transducer detects the acoustic signal and outputs an acoustic waveform correlated to the acoustic signal. In other variations, the detector element 306 comprises an optical transducer element. In this embodiment, the modulated access signal 305 comprises an optical signal, adapted for transmission in an optical communications channel. The optical transducer element is adapted to detect the optical signal in the optical communications channel. In one embodiment, the optical transducer element is adapted to transform the optical signal into an electrical waveform. In other embodiments, the optical transducer element is adapted to transform the optical signal into, inter alia, an acoustic waveform or an optical waveform.

The receiver element 310 is adapted to receive the detector output signal 308 of the detector element 306. The receiver element 310 is further adapted to perform at least one signal processing function. The receiver element also comprises a receiver output signal 312. In one embodiment, the signal processing function comprises, inter alia, amplifying an amplitude of the detector output signal 308, downconverting the detector output signal 308, demodulating the detector output signal 308, and/or correcting phase distortions in the detector element output signal 308.

The security access system 300 further comprises a computational element 314, adapted to accept the receiver output signal 312. The computational element 314 is further adapted to compare the receiver output signal 312 with a predetermined access code, wherein the predetermined access code is stored in a memory element accessible by the computational element 314. In one embodiment, the computational element 314 comprises a microprocessor element. The computational element 314 calculates an output value 316, reflective of a comparative result of the receiver output signal 312 with the predetermined access code. In one embodiment, the memory element comprises, inter alia, a magnetic storage medium, an optical storage medium, a semiconductor memory element, a compact disk element, a digital video disk element, an internet based database element such as the Internet, or a computer readable medium.

If the output value 316 approximately matches the predetermined access code, a user of a security access system is granted access. If, on the other hand, the output value 316 does not approximately match the predetermined access code, a user is denied access. The present teachings are useful for providing security to any structure for which a user may desire security comprising, inter alia, a house, building, office, vault, locker, storage area, or trunk.

For further reference regarding enabling security access systems, the following references are incorporated by reference in their entirety, as if disclosed herein in full: U.S. Pat. No. 4,890,108 to Drori et al., entitled, “Multi-Channel Remote Control Transmitter”; U.S. Pat. No. 5,650,774 to Drori, entitled, “Electronically Programmable Remote Control Access System”; U.S. Pat. No. 6,561,151 to Wisnia et al., entitled, “Remote Control Car Starter”; U.S. Pat. No. 4,887,064 to Drori et al., entitled, “Multi-featured Security System with Self-Diagnostic Capability”; U.S. Pat. No. 6,467,448 to Wisnia et al., entitled, “Remote Engine Starter System”; U.S. Pat. No. 4,922,224 to Drori et al., entitled, “Electronic Vehicle Security System”; U.S. Pat. No. 5,534,845 to Issa et al., entitled, “Advanced Automotive Automation and Security System”.

The foregoing description illustrates exemplary implementations, and novel features, of aspects of an apparatus for accessing a security system. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. A vehicle access security system, comprising:
a) a transmitter element, adapted to transmit a modulated vehicle access signal into a predetermined communications channel, the predetermined communications channel selected from a group consisting of:
i) an acoustic communications channel, or;
ii) an optical communications channel;
b) a detector element, adapted to detect the modulated vehicle access signal in the predetermined communications channel transmitted by the transmitter element, the detector element having a detector output signal;
c) a receiver element, adapted to receive the detector output signal of the detector element, the receiver element further adapted to perform at least one signal processing function, the receiver element having a receiver output signal, wherein the at least one signal processing function is selected from the group consisting of:
i) amplifying an amplitude of the detector output signal;
ii) downconverting the detector output signal;
iii) demodulating the detector output signal, or;
iv) correcting phase distortions in the detector output signal, and;
d) a computational element, adapted to accept the receiver output signal, the computational element further adapted to compare the receiver output signal with a predetermined access code, wherein the predetermined access code is stored in a memory element accessible by the computational element, whereby the computational element further calculates an output value of the computational element reflective of a comparative result of the receiver output signal with the predetermined access code.

2. The vehicle access security system of claim 1, wherein the transmitter element is selected from the group consisting of:
a) a cellular telephone;
b) an audio player;
c) a wireless telephone;
d) a key FOB;
e) an LCD screen;
f) an optical transmitter, or;
g) an audio transmitter.

3. The vehicle access security system of claim 2, wherein the modulated vehicle access signal is modulated using a modulation format selected from the group consisting of:
a) frequency modulation;
b) amplitude modulation;
c) phase modulation;
d) quadrature phase shift keying;
e) quadrature amplitude modulation;
f) frequency shift keying, or;
g) on-off keying.

4. The vehicle access security system of claim 3, wherein the acoustic communications channel is selected from a group consisting of:
a) an audio channel, or;
b) an ultrasonic channel.

5. The vehicle access security system of claim 4, wherein the optical communications channel is selected from a group consisting of:
a) an infrared communications channel;
b) a visible light communications channel, or;
c) an ultraviolet communications channel.

6. The vehicle access security system of claim 5, wherein the detector element is selected from the group consisting of:
a) a microphone element;
b) a photo detector element;
c) an audio transducer, or;
d) an optical transducer.

7. The vehicle access security system of claim 6, wherein the computational element comprises a microprocessor element.

8. The vehicle access security system of claim 7, wherein the memory element is selected from the group consisting of:
a) a semiconductor memory element;
b) a compact disk element;
c) a digital video disk element;
d) an Internet based database element, or;
e) a computer readable medium.

9. A vehicle access security module, comprising:
a) a detector element, adapted to detect a modulated vehicle access signal in a predetermined communications channel, the detector element having a detector output signal, the predetermined communications channel selected from a group consisting of:
i) an acoustic communications channel, or;
ii) an optical communications channel;
b) a receiver element, adapted to receive the detector output signal of the detector element, the receiver element further adapted to perform at least one signal processing function, the receiver element having a receiver output signal, wherein the at least one signal processing function is selected from the group consisting of:
i) amplifying an amplitude of the detector output signal;
ii) downconverting the detector output signal;
iii) demodulating the detector output signal, or;
iv) correcting phase distortions in the detector output signal, and;
c) a computational element, adapted to accept the receiver output signal, the computational element further adapted to compare the receiver output signal with a predetermined access code, wherein the predetermined access code is stored in a memory element accessible by the computational element, whereby the computational element further calculates an output value of the computational element reflective of a comparative result of the receiver output signal with the predetermined access code.

10. The vehicle access security module of claim 9, wherein the modulated vehicle access signal is modulated using a modulation format selected from the group consisting of:
a) frequency modulation;
b) amplitude modulation;
c) phase modulation;
d) quadrature phase shift keying;
e) quadrature amplitude modulation;
f) frequency shift keying, or;
g) on-off keying.

11. The vehicle access security module of claim 10, wherein the acoustic communications channel is selected from a group consisting of:
a) an audio channel, or;
b) an ultrasonic channel.

12. The vehicle access security module of claim 11, wherein the optical communications channel is selected from a group consisting of:
a) an infrared communications channel;
b) a visible light communications channel, or;
c) an ultraviolet communications channel.

13. The vehicle access security module of claim 12, wherein the detector element is selected from the group consisting of:
a) a microphone element;
b) a photo detector element;
c) an audio transducer, or;
d) an optical transducer.

14. The vehicle access security module of claim 13, wherein the computational element comprises a microprocessor element.

15. The vehicle access security system of claim 14, wherein the memory element is selected from the group consisting of:
a) a semiconductor memory element;
b) a compact disk element;
c) a digital video disk element;
d) an Internet based database element, or;
e) a computer readable medium.

16. A security access system, comprising:
a) a transmitter element, adapted to transmit a modulated access signal into a predetermined communications channel, the predetermined communications channel selected from a group consisting of:
i) an acoustic communications channel, or;
ii) an optical communications channel;
b) a detector element, adapted to detect the modulated access signal in the predetermined communications channel transmitted by the transmitter element, the detector element having a detector output signal;
c) a receiver element, adapted to receive the detector output signal of the detector element, the receiver element further adapted to perform at least one signal processing function, the receiver element having a receiver output signal, wherein the at least one signal processing function is selected from the group consisting of:
i) amplifying an amplitude of the detector output signal;
ii) downconverting the detector output signal;
iii) demodulating the detector output signal, or;
iv) correcting phase distortions in the detector output signal, and;
d) a computational element, adapted to accept the receiver output signal, the computational element further adapted to compare the receiver output signal with a predetermined access code, wherein the predetermined access code is stored in a memory element accessible by the computational element, whereby the computational element further calculates an output value of the computational element reflective of a comparative result of the receiver output signal with the predetermined access code.

17. The access security module of claim 16, wherein the modulated access signal is modulated using a modulation format selected from the group consisting of:
a) frequency modulation;
b) amplitude modulation;
c) phase modulation;
d) quadrature phase shift keying;
e) quadrature amplitude modulation;
f) frequency shift keying, or;
g) on-off keying.

18. The access security module of claim 17, wherein the acoustic communications channel is selected from a group consisting of:
a) an audio channel, or;
b) an ultrasonic channel.

19. The access security module of claim 18, wherein the optical communications channel is selected from a group consisting of:
a) an infrared communications channel;
b) a visible light communications channel, or;
c) an ultraviolet communications channel.

20. The access security module of claim 19, wherein the detector element is selected from the group consisting of:
a) a microphone element;
b) a photo detector element;
c) an audio transducer, or;
d) an optical transducer.

21. The access security module of claim 20, wherein the computational element comprises a microprocessor element.

22. The access security system of claim 21, wherein the memory element is selected from the group consisting of:
a) a semiconductor memory element;
b) a compact disk element;
c) a digital video disk element;
d) an Internet based database element, or;
e) a computer readable medium.

23. A method for accessing a security system, comprising:
a) providing a means for transmitting into a predetermined communications channel an access signal;
b) transmitting the access signal into the predetermined communications channel the access signal;
c) providing detecting means, responsive to the transmitting means, for detecting the access signal transmitted into the predetermined communications channel, wherein the detecting means outputs a detecting means output signal;
d) providing receiving means, responsive to the detecting means, for receiving the detecting means output signal, wherein the receiving means outputs a receiving means output signal, and;
e) providing computing means, responsive to the receiving means, for comparing the receiving means output signal with a predetermined access code.
